(19) United States
(12) Patent Application Publication
(10) Pub. No.: US 2026/0361559 A1
(43) Pub. Date: Nov. 12, 2026

(54) CHARGING PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Jinhua WU, Beijing (CN); Yang SHEN, Beijing (CN); Jianning LIU, Beijing (CN); Yuxin MAO, Beijing (CN)

(73) Assignee: Beijing Xiaomi Mobile Software Co., Ltd., Beijing (CN)

(21) Appl. No.: 19/102,039

(22) PCT Filed: Aug. 9, 2022
(86) PCT No.: PCT/CN2022/111279

§ 371 Date: Feb. 7, 2025

(51) Int. Cl. H04L 12/14; H04L 69/322

(52) U.S. Cl. CPC H04L 12/1407; H04L 69/322

(57) ABSTRACT

Charging processing methods and apparatuses, a communication device, and a storage medium are provided. The method is performed by an access network node and includes: receiving a charging offset indication sent by a session management function (SMF) entity; and determining, according to the charging offset indication, whether a charging correction for one or more dropped data packets is to be performed.

### CROSS-REFERENCE TO RELATED APPLICATIONS

The present disclosure is a U.S. national phase of PCT Application No. PCT/CN2022/111279 filed on Aug. 9, 2022, the content of which is hereby incorporated by reference in its entirety.

### TECHNICAL FIELD

The present disclosure relates to, but is not limited to, a field of wireless communication technology, and in particular, to charging processing methods and apparatuses, a communication device, and a storage medium.

### BACKGROUND

At present, a 5-th generation cellular mobile communication system (5GS) adopts a general quality of service (QoS) mechanism, to process various types of data services including an extended reality (XR) service and/or a multimodal data service.

### SUMMARY

A first aspect of the embodiments of the present disclosure provides a charging processing method. The method is performed by an access network node and includes: receiving a charging offset indication sent by a session management function (SMF) entity; and determining, according to the charging offset indication, whether a charging correction for one or more dropped data packets is to be performed.

A second aspect of the embodiments of the present disclosure provides a charging processing method. The method is performed by a PCF entity and includes: sending a charging offset indication to an SMF entity, where the charging offset indication indicates whether an access network node is to perform a charging correction for one or more dropped data packets.

A third aspect of the embodiments of the present disclosure provides a charging processing method. The method is performed by an SMF entity and includes: sending a charging offset indication to an access network node, where the charging offset indication indicates whether the access network node is to perform a charging correction for one or more dropped data packets.

A fourth aspect of the embodiments of the present disclosure provides a communication device, including: a processor; and a memory storing instructions executable by the processor; where the processor is configured to implement, when executing the instructions, the charging processing method of any one of the embodiments in the first aspect, the second aspect, or the third aspect.

A fifth aspect of the embodiments of the present disclosure provides a communication system, including: a PCF entity, an SMF entity, and an access network node; where the PCF entity is configured to perform the charging processing method of any one of the embodiments in the second aspect; the SMF entity is configured to perform the charging processing method of any one of the embodiments in the third aspect; and the access network node is configured to perform the charging processing method of any one of the embodiments in the first aspect.

A sixth aspect of the embodiments of the present disclosure provides a computer storage medium. The computer storage medium stores a computer executable program. When the executable program is executed by a processor, the charging processing method in the first aspect, the second aspect, or the third aspect is implemented.

It should be understood that the above general description and the detailed description in the following text are only exemplary and explanatory, and cannot limit the embodiments of the present disclosure.

### BRIEF DESCRIPTION OF DRAWINGS

The accompanying drawings herein are incorporated into the specification and form a part of the specification, show embodiments conforming to the present disclosure, and are used together with the specification to explain principles of embodiments of the present disclosure.

FIG. 1 is a schematic structural diagram of a wireless communication system shown according to an exemplary embodiment.

FIG. 2 is a schematic flowchart of a charging processing method shown according to an exemplary embodiment.

FIG. 3 is a schematic flowchart of a charging processing method shown according to an exemplary embodiment.

FIG. 4 is a schematic flowchart of a charging processing method shown according to an exemplary embodiment.

FIG. 5 is a schematic flowchart of a charging processing method shown according to an exemplary embodiment.

FIG. 6 is a schematic flowchart of a charging processing method shown according to an exemplary embodiment.

FIG. 7A is a schematic flowchart of a charging processing method shown according to an exemplary embodiment.

FIG. 7B is a schematic flowchart of a charging processing method shown according to an exemplary embodiment.

FIG. 7C is a schematic flowchart of a charging processing method shown according to an exemplary embodiment.

FIG. 8 is a schematic structural diagram of an access network node shown according to an exemplary embodiment.

FIG. 9 is a schematic structural diagram of a policy control function (PCF) entity shown according to an exemplary embodiment.

FIG. 10 is a schematic structural diagram of a session management function (SMF) entity shown according to an exemplary embodiment.

FIG. 11 is a schematic structural diagram of a communication device shown according to an exemplary embodiment.

### DETAILED DESCRIPTION

Exemplary embodiments will be described in details herein, with examples thereof represented in the accompanying drawings. When the following description involves the accompanying drawings, same numerals in different figures represent same or similar elements unless otherwise indicated. Implementations described in the following exemplary embodiments do not represent all implementations consistent with embodiments of the present disclosure. Rather, they are only examples of apparatuses and methods that are consistent with some aspects of embodiments of the present disclosure.

Terms used in the embodiments of the present disclosure are only for a purpose of describing specific embodiments, and are not intended to limit the embodiments of the present disclosure. Singular forms, “a/an,” “the,” and “this,” used in the present disclosure are also intended to include majority forms, unless the context clearly indicates other meanings. It should also be understood that the term “and/or” used herein refers to and includes any or all possible combinations of one or more related listed items.

It should be understood that although terms, such as “first,” “second,” “third,” etc., may be used in the embodiments of the present disclosure to describe various information, such information should not be limited by these terms. These terms are only used to distinguish a same type of information from each other. For example, without departing from the scope of the embodiments of the present disclosure, first information may also be referred to as second information, and similarly, the second information may also be referred to as the first information. Depending on the context, the term “if” used herein may be interpreted as “when,” “while,” or “in response to determining.”

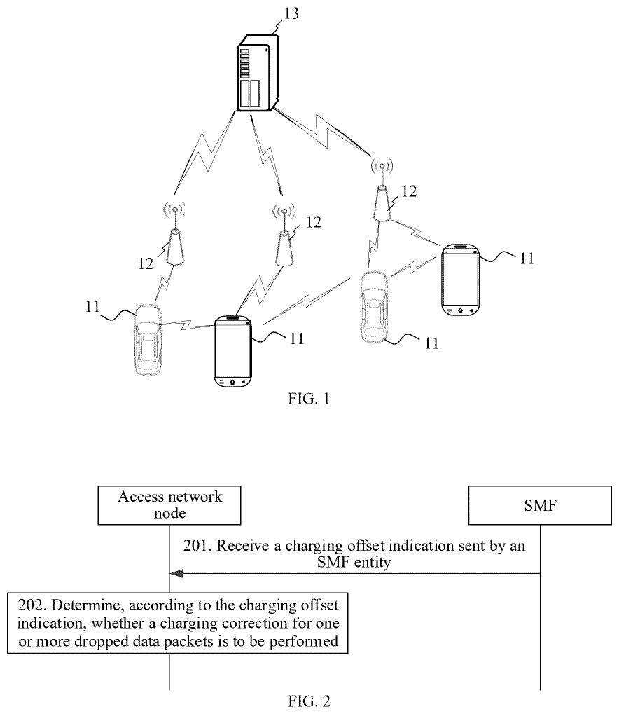

Referring to FIG. 1, FIG. 1 shows a schematic structural diagram of a wireless communication system provided by an embodiment of the present disclosure. As shown in FIG. 1, the wireless communication system is a communication system based on a cellular mobile communication technology, and the wireless communication system may include several user equipments (UEs) 11 and several access network devices 12.

The user equipment 11 may be a device that provides voice and/or data connectivity to a user. The user equipment 11 may communicate with one or more core networks through a radio access network (RAN). The user equipment 11 may be Internet of Things user equipment, such as a sensor device, a mobile phone (or referred to as a “cellular” phone), and a computer having the Internet of Things user equipment, for example a fixed, portable, pocket, handheld, computer built-in, or vehicle-mounted apparatus. For example, the user equipment may be a station (STA), a subscriber unit, a subscriber station, a mobile station, a mobile table, a remote station, an access point, a remote terminal, an access terminal, a user terminal, a user agent, or a user device. Alternatively, the user equipment 11 may be a wearable device, a virtual reality (VR) device, an augmented reality (AR) device, or a VR/AR hybrid head-mounted device. Alternatively, the user equipment 11 may be a device of an unmanned aerial vehicle. Alternatively, the user equipment 11 may also be a vehicle-mounted device, for example, a vehicle computer having a wireless communication function, or a wireless user device externally connected to a vehicle computer. Alternatively, the user equipment 11 may also be a roadside device, for example, a street lamp, a signal light, other roadside device, etc., having a wireless communication function.

The access network device 12 may be a device communicating with the user equipment 11 in a wireless communication system, and may be a base station, an access point, or a network device; or the access network device 12 may be a device that communicates with a wireless terminal through one or more sectors on an air interface in an access network. The network device may be used as a router between the wireless terminal and the rest part of the access network, to perform mutual conversion between received air frames and an Internet Protocol (IP) packet, where the rest part of the access network may include an IP network. The network device may also coordinate attribute management for the air interface. The wireless communication system may be a 4-th generation mobile communication (4G) system, also referred to as a long term evolution (LTE) system; or the wireless communication system may also be a 5G system, also referred to as a new radio (NR, or new air interface) system or a 5G NR system. Alternatively, the wireless communication system may be a next generation system of the 5G system. The access network in the 5G system may be referred to as an NG-RAN (new generation-radio access network).

The access network device 12 may be an evolved access device (eNB) used in the 4G system. Alternatively, the access network device 12 may also be a base station using a centralized distributed architecture access device (gNB) in the 5G system. When the access network device 12 uses the centralized distributed architecture, the base station usually includes a central unit (CU) and at least two distributed units (DUs). The central unit is provided with a protocol stack of a packet data convergence protocol (PDCP) layer, a radio link control (RLC) layer, and a media access control (MAC) layer; and the distributed unit is provided with a protocol stack of a physical (PHY) layer. The specific implementation of the access network device 12 is not limited in the embodiment of the present disclosure.

A wireless connection may be established between the access network device 12 and the UE 11 through a wireless air interface. In different implementations, the wireless air interface is a wireless air interface based on a 4-th generation mobile communication network technology (4G) standard; or the wireless air interface is a wireless air interface based on a 5-th generation mobile communication network technology (5G) standard, for example, the wireless air interface is a new radio; or the wireless air interface may also be a wireless air interface based on a next generation mobile communication network technology standard of the 5G.

In some embodiments, an E2E (end to end) or D2D (device to device) connection may also be established between the user equipments 11. For example, there are scenarios, such as V2V (vehicle to vehicle) communication, V2I (vehicle to infrastructure) communication, V2P (vehicle to pedestrian) communication, etc., in V2X (vehicle to everything) communication.

In some embodiments, the above wireless communication system may further include a core network device 13. The several access network devices 12 are respectively connected to the core network device 13.

In some embodiments, the core network device 13 may be a mobility management entity (MME) in an evolved packet core (EPC) network. Alternatively, the core network device may also be a serving gateway (SGW), a public data network gateway (PGW), a policy and charging rules function (PCRF), a home subscriber server (HSS), etc.

In some embodiments, the core network device 13 may be an access and mobility management function (AMF) entity, a session management function (SMF) entity, a user plane function (UPF) entity, a policy control function (PCF) entity, a network repository function (NRF) entity, etc.

A main function of the core network device includes the following.

The SMF entity is responsible for session management, including the establishment, modification, release, etc., of a PDU session.

The PCF entity is responsible for user policy management, including both mobility related policies and related policies of the PDU session, such as a QoS policy, a charging policy, etc.

The UPF entity is responsible for forwarding user data.

The PCF entity, the SMF entity, the UPF entity, etc., in the embodiments of the present disclosure may be implemented by an entity device, or may be jointly implemented by a plurality of entity devices. It may be understood that the PCF entity, the SMF entity, etc., in the embodiments of the present disclosure may be a logical function module in an entity device, or may be a logical function module formed by a plurality of entity devices, which is not limited in the embodiments of the present disclosure.

For ease of understanding by those skilled in the art, the embodiments of the present disclosure list a plurality of implementations to clearly describe technical solutions of the embodiment of the present disclosure. Of course, those skilled in the art may understand that the plurality of embodiments provided by the embodiments of the present disclosure may be executed separately, or may be executed together with methods of other embodiments in embodiments of the present disclosure, or may be executed separately or together with some methods in other related technologies, which is not limited in the embodiments of the present disclosure.

XR services such as mobile media services, cloud augmented reality (AR)/virtual reality (VR) services, cloud games, video-based machine or unmanned aerial vehicle remote control services, etc., are expected to contribute increasingly high traffic to the 5G network. In addition to audio and video flows, the XR services involve multimodal data flows, such as data flows for biological tactile perception. These multimodal data are data, describing the same service or application, input from the same device or different devices (including sensors), and these data may be output to one or more destination device terminals. Each data flow in the multimodal data often has a certain or even strong correlation, such as audio and video flow synchronization, haptic and visual synchronization, etc. The data flows of such media services, among the data flows, and the requirements of the data flows of these services for network transmission all have some common features, and the effective identification and utilization of these features will be more conducive to the transmission and control of networks and services, and also to the service assurance and user experience.

The XR media data flow has characteristics of high bandwidth, low latency, and high reliability requirements, and QoS requirements of data units and data sets in the data flow need to be further matched, so as to effectively improve user experience.

In related technologies, the 5GS does not support charging corresponding to QoS enhancement of XR service data flows. For example, after a UPF entity performs charging statistics and reporting for downlink data, an RAN initiatively drops remaining data packets in the data set and/or data packets in a related data set, and initiatively drops charged data packets in batches, based on the QoS characteristic or requirement matching between data units in a data set and/or between data sets, resulting in an inaccurate charging result.

FIG. 2 is a flowchart of a charging processing method shown according to an exemplary embodiment. As shown in FIG. 2, the charging processing method is performed by an access network node and includes steps 201-202.

At step 201, a charging offset indication sent by an SMF entity is received.

At step 202, according to the charging offset indication, whether a charging correction for one or more dropped data packets is to be performed is determined.

The access network node may be a base station, for example, a base station of a 5G network or another evolved base station.

The charging offset indication indicates whether a charging correction for one or more dropped data packets is to be performed.

In some examples, the one or more dropped data packets may include: one or more PDU sets initiatively dropped by the access network node and/or one or more data packets, in a PDU set, initiatively dropped by the access network node.

A PDU set is composed of one or more PDUs, and the PDUs carry valid data of an information unit generated by an application layer, for example, frames or video slices used for an XRM (extended reality media) service.

In some embodiments, the application layer needs to use all PDUs in the PDU set to correspond to the information unit. In other embodiments, when some PDUs are lost, the application layer can still recover all or part of the information unit.

In some examples, the one or more dropped data packets may include at least one of: a PDU set with a priority lower than a specified priority, a PDU set with an importance lower than a specified importance, a data packet with the priority lower than a preset priority in the PDU set, or a data packet with an importance lower than the preset importance in the PDU set.

In some examples, when a value of the charging offset indication is a first value, it indicates that the charging correction for the dropped data packets needs or is allowed to be performed. When a value of the charging offset indication is a second value, it indicates that the charging correction for the dropped data packets does not need or is not allowed to be performed.

For example, the first value is “charging offset”, and the second value is “non-offset”. For another example, the first value is 1, and the second value is 0.

In some other examples, the charging offset indication may include a data volume threshold, and the data volume threshold is for determining whether the charging correction for the dropped data packets is to be performed.

For example, when the volume of the dropped data packets is greater than the data volume threshold, it indicates that the charging correction for the dropped data packets needs or is allowed to be performed. When the volume of the dropped data packets is less than or equal to the data volume threshold, it indicates that the charging correction for the dropped data packets does not need or is not allowed to be performed.

In some examples, the charging offset indication may be generated by the PCF entity according to subscription information or a local policy.

The PCF entity may generate the charging offset indication according to the subscription information or the local policy, and send the charging offset indication to the access network node via the SMF entity.

In the step 201, the charging offset indication may be obtained by the SMF entity from the PCF entity, and sent by the SMF entity to the access network node.

In some examples, the charging offset indication may be obtained by the SMF entity from the PCF entity in an establishment or modification procedure of a packet data unit (PDU) session.

In the charging processing method provided by the embodiment of the present disclosure, the access network node receives the charging offset indication sent by the SMF entity, and determines, according to the charging offset indication, whether the charging correction for the dropped data packets is to be performed, which can improve an accuracy of a charging result.

In an embodiment, accuracy the charging offset indication is carried in charging information included in a policy control and charging (PCC) rule; and/or the charging offset indication is carried in related policy information of a PDU session; and/or the charging offset indication is carried in related policy information of a PDU set.

In some examples, the PCC rule includes a related QoS parameter and charging information of the PDU set, and the charging offset indication may be carried in the charging information.

In some other examples, the related policy information of the PDU session includes a charging parameter of the PDU session, and the charging offset indication may be carried in the charging parameter included in the related policy information of the PDU session.

In some still other examples, the related policy information of the PDU set includes the charging parameter, and the charging offset indication may be carried in the charging parameter included in the related policy information of the PDU set.

In some examples, both the related policy information of the PDU session and the related policy information of the PDU set may be included in the PCC rule.

In some examples, the PCC rule may be associated with a user identifier of the terminal.

In some examples, the PCC rule is provided by the PCF entity to the SMF entity.

For example, the charging offset indication may be included in information of the PCC rule, as shown in Table 1.

TABLE 1
information of PCC rule in 5G core network (5GC)

| | | | PCF entity | |
|---|---|---|---|---|
| | | | permitted to | |
| | | | modify for a | Differences |
| | | | dynamic PCC | compared |
| Information | | | rule in the | with related |
| name | Description | Category | SMF entity | technologies |
| Rule | Uniquely identifying the PCC rule | Mandatory | No | None |
| identifier | within a PDU session. | | | |
| | It is used between PCF entity and | | | |
| | SMF entity for referencing PCC | | | |
| | rule. | | | |
| Charging | This part defines IDs and | | | |
| | instructions for charging and | | | |
| | counting that is required for an | | | |
| | access point where flow based | | | |
| | charging is configured. | | | |
| Charging | Charging system (CHF) uses the | | Yes | None |
| key | charging key to determine the | | | |
| (Note 22) | charging applied to the service | | | |
| | data flow. | | | |
| Service | The identifier of the service or | | Yes | None |
| identifier | service component relates to the | | | |
| | service data flow in a rule. | | | |
| Measuring | Indicating whether the volume, | | Yes | None |
| method | the duration, combination of the | | | |
| | volume and the duration, or the | | | |
| | event of the service data flow | | | |
| | data shall be measured. | | | |
| | This is applicable to reporting, | | | |
| | if the charging method is online | | | |
| | or offline. | | | |
| | Note: Event based charging is | | | |
| | only applicable to predefined PCC | | | |
| | rules and PCC rules used for | | | |
| | application detection filter (i.e. | | | |
| | with an application identifier). | | | |
| Application | Identifier provided from the AF | | No | None |
| function | entity correlates the measurement | | | |
| (AF) record | for the charging key/service | | | |
| information | identifier values in this PCC rule | | | |
| | with application level reports. | | | |
| Service | Indicating that separate usage | | Yes | None |
| identifier | reports shall be generated for | | | |
| level | this service identifier. | | | |
| reporting | Values: Mandatory or not | | | |
| | required | | | |
| Charging | Indicating whether the charging | | Yes | New |
| offset while | offset is needed/allowed while | | | |
| the PDU set | PDU set based QoS handling. | | | |
| based QoS | Values: Charging offset or non- | | | |
| handling | offset. | | | |

For another example, the charging offset indication may be included in related policy information of the PDU session, as shown in Table 2.

TABLE 2
related policy information of PDU session.

| | | PCF entity | | |
|---|---|---|---|---|
| | | permitted to | | Differences |
| | | modify for | | compared |
| | | dynamically | | with |
| | | provided | | related |
| Attribute | Description | information | Scope | technologies |
| Charging | Defining the containing CHF | No | PDU | None |
| information | address and optionally the | | session | |
| | associated CHF instance ID | | | |
| | and CHF set ID. | | | |
| Default | Defining the default charging | No | PDU | None |
| charging | method for the PDU session. | | session | |
| method | | | | |
| PDU session | Indicating that the “online” | No | PDU | Added |
| with offline | charging method is never | | session | |
| charging only | used for the PCC rule in the | | | |
| | PDU session. | | | |
| Charging | Indicating whether the | Yes | PDU | Added |
| offset while | charging offset is | | session | |
| the PDU set | needed/allowed while PDU | | | |
| based QoS | set based QoS handling. | | | |
| handling | Values: Charging offset | | | |
| | or non-offset. | | | |

In an embodiment, the one or more dropped data packets include: one or more PDU sets initiatively dropped by the access network node and/or one or more data packets, in a PDU set, initiatively dropped in PDU set based QoS handling.

For a service data flow in a downlink direction, the access network node initiatively drops remaining data packets in the data set and/or data packets in the related data set, based on QoS characteristic or requirement matching between data units in a PDU set and/or between PDU sets (for example, dependency relationships between data units in a PDU set, dependency relationships between PDU sets, importances/priorities of the data units in the PDU set, importances/priorities of the PDU sets, etc.).

In an embodiment, the one or more initiatively dropped PDU sets include at least one of: a PDU set with a transmission delay time exceeding a PDU set transmission delay budget; a PDU set with a transmission error rate exceeding a PDU set transmission error rate threshold; a second PDU set that is initiatively dropped based on a transmission failure of a first PDU set; a PDU set with a priority lower than a preset priority; a PDU set depending on other PDU sets; or a PDU set with an importance lower than a preset importance.

In an embodiment, the first PDU set and the second PDU set have a relationship including at least one of: the second PDU set depending on the first PDU set; an importance of the second PDU set being lower than an importance of the first PDU set; or a priority of the second PDU set being lower than a priority of the first PDU set.

The PDU set transmission delay budget, the PDU set transmission error rate threshold, the dependency relationship between PDU sets, and the importance of the PDU set may all be included in related QoS parameters of the PDU sets.

The PDU set that is failure-transmitted may be a PDU set that is not successfully received by the access network node within a set duration.

For example, taking a dependency relationship between PDU sets as an example, for a PDU set #1 and a PDU set #2, if the PDU set #1 is failure-transmitted and the PDU set #2 depends on the PDU set #1, the PDU set #1 is the first PDU set, and the PDU set #2 may be the second PDU set that is initiatively dropped by the access network node.

For another example, taking a priority relationship between PDU sets as an example, for the PDU set #1 and the PDU set #2, if the PDU set #1 is failure-transmitted and a priority of the PDU set #2 is low than a priority of the PDU set #1, the PDU set #1 is the first PDU set, and the PDU set #2 may be the second PDU set that is initiatively dropped by the access network node.

For still another example, taking the importance of the PDU set as an example, for the PDU set #1 and the PDU set #2, if the PDU set #1 is failure-transmitted and the importance of the PDU set #2 is low than the importance of the PDU set #1, the PDU set #1 is the first PDU set, and the PDU set #2 may be the second PDU set that is initiatively dropped by the access network node.

For still another example, there may be a transmission delay time when the PDU set is transmitted between the UE and the UPF entity, and if a transmission delay time of a PDU set exceeds the PDU set transmission delay budget, the PDU set may be initiatively dropped by the access network node.

There may be a transmission error rate when the PDU set is transmitted between the UE and the UPF entity, and if a transmission error rate of a PDU set exceeds the PDU set transmission error rate threshold, the PDU set may be initiatively dropped by the access network node.

The PDU set may be configured with a corresponding priority, and if a priority of a PDU set is lower than a preset priority, the PDU set may be initiatively dropped by the access network node.

A corresponding dependency relationship may be configured between PDU sets, and if a PDU set depends on other PDU sets, the PDU set may be initiatively dropped by the access network node.

The PDU set may be configured with a corresponding importance, and if an importance of a PDU set is lower than a preset importance, the PDU set may be initiatively dropped by the access network node.

In an embodiment, the one or more initiatively dropped data packets include at least one of:
a data packet with a transmission delay time exceeding a data packet transmission delay budget;
a data packet with a transmission error rate exceeding a data packet transmission error rate threshold;
a second data packet that is initiatively dropped based on a transmission failure of a first data packet;
a data packet with a priority lower than a preset priority;
a data packet depending on other data packets; or
a data packet with an importance lower than a preset importance.

In an embodiment, the first data packet and the second data packet belong to a same PDU set, and have a relationship including at least one of:
the second data packet depending on the first data packet;
an importance of the second data packet being lower than an importance of the first data packet; or
a priority of the second data packet being lower than a priority of the first data packet.

The data packet transmission delay budget, the data packet transmission error rate threshold, the dependency relationship between the data packets in the same PDU set, and the importances of the data packets may all be included in related QoS parameters of the PDU sets.

The data packet that is failure-transmitted may be a data packet in a PDU set that is not successfully received by the access network node within a set duration.

For example, taking a dependency relationship between data packets in a PDU set as an example, for a PDU #1 and a PDU #2 in a certain PDU set, if the PDU #1 is failure-transmitted and the PDU #2 depends on the PDU #1, the PDU #1 is the first data packet, and the PDU #2 may be the second data packet that is initiatively dropped by the access network node.

For another example, taking the importances of data packets in a PDU set as an example, for the PDU #1 and the PDU #2 in a certain PDU set, if the PDU #1 is failure-transmitted and the importance of the PDU #2 is low than the importance of the PDU #1, the PDU #1 is the first data packet, and the PDU #2 may be the second data packet that is initiatively dropped by the access network node.

For still another example, taking a priority relationship between data packets in a PDU set as an example, for a PDU #1 and a PDU #2 in a certain PDU set, if the PDU #1 is failure-transmitted and a priority of the PDU #2 is low than a priority of the PDU #1, the PDU #1 is the first data packet, and the PDU #2 may be the second data packet that is initiatively dropped by the access network node.

For still another example, there may be a transmission delay time when a data packet in the PDU set is transmitted between the UE and the UPF entity, and if a transmission delay time of a data packet in a PDU set exceeds the data packet transmission delay budget, the data packet may be initiatively dropped by the access network node.

There may be a transmission error rate when a data packet in the PDU set is transmitted between the UE and the UPF entity, and if a transmission error rate of a data packet exceeds the data packet transmission error rate threshold, the data packet may be initiatively dropped by the access network node.

A data packet in the PDU set may be configured with a corresponding priority, and if a priority of a data packet is lower than a preset priority, the data packet may be initiatively dropped by the access network node.

A corresponding dependency relationship may be configured between different data packets in the same PDU set, and if a data packet depends on other data packets, the data packet may be initiatively dropped by the access network node.

Different data packets in the same PDU set may be configured with corresponding importances, and if an importance of a data packet is lower than a preset importance, the data packet may be initiatively dropped by the access network node.

In an embodiment, a data flow for the one or more dropped data packets is an XR service data flow or a multimodal data service data flow.

The data flow may be a service data flow provided by the core network to the terminal via the access network node in response to a service request of the terminal.

In this embodiment, both the XR service data flow and the multimodal data service data flow have the characteristics of high bandwidth, low latency, and high reliability requirements. For downlink transmission of these types of service data flows, when the access network node matches the QoS or requirement for a data unit and/or a data set in the data flow, the access network node initiatively drops a data packet, to determine, through a charging offset indication, whether the charging correction for the dropped data packet is to be performed, which can improve the accuracy of the charging result.

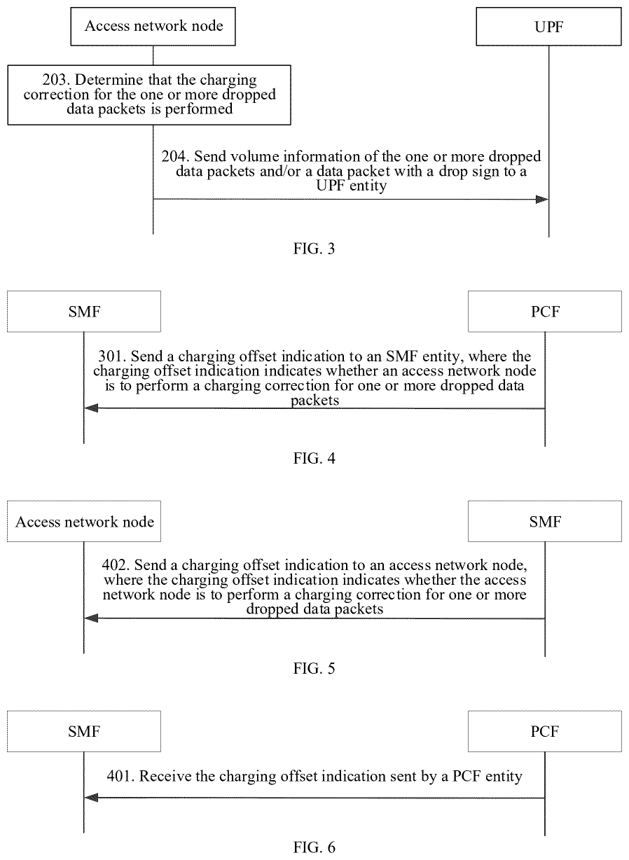

In an embodiment, as shown in FIG. 3, the method further includes steps 203-204.

At step 203, it is determined that the charging correction for the one or more dropped data packets is performed.

Specifically, when the value of the charging offset indication is a charging offset, it is determined that the charging correction for the one or more dropped data packets is performed.

At step 204, volume information of the one or more dropped data packets and/or a data packet with a drop sign is sent to a UPF entity.

In this embodiment, in case of determining that the charging correction for the dropped data packets is performed, the access network node may count volume information of the one or more dropped data packets, and send the volume information of the one or more dropped data packets and the corresponding user identifier to the UPF entity, or may send a data packet with a drop sign and the corresponding user identifier to the UPF entity.

If receiving the volume information of the one or more dropped data packets, the UPF entity may report the volume information of the one or more dropped data packets to a charging function network element. The charging function network element may determine charging corresponding to the volume information of the one or more dropped data packets, and subtract the charging corresponding to the volume information of the one or more dropped data packets from the total charging that has been counted.

If receiving the data packet with the drop sign, the UPF entity may count volume information of the data packet with the drop sign, and report the counted volume information of the data packet with the drop sign to the charging function network element.

In an embodiment, one or more charging scenarios for the charging correction include at least one of:
a scenario of charging based on the volume;
a scenario of charging based on combination of the volume and a time;
a scenario of charging based on combination of the volume and an event; or
a scenario of charging based on combination of the volume, the time, and the event.

When the charging is performed based on the combination of the volume and the time, the charging may be performed according to the volume of the service data flow and time information (the time information includes for example a starting moment and an ending moment).

When the charging is performed based on the combination of the volume and the event, the charging may be performed according to the volume of the service data flow and event information (the event information is for example a service type of the service data flow).

In some examples, the charging scenarios for the charging correction may be determined according to charging policy information, and the charging policy information is for example charging information in the PCC rule.

In this embodiment, flexibility of charging processing is improved, by providing a plurality of charging scenarios for the charging correction.

In an embodiment, one or more charging methods for the charging correction include at least one of:
online charging;
offline charging; or
integrating charging.

The integrating charging refers to charging in which the online charging and the offline charging are integrated.

In some examples, the charging methods for the charging correction may be determined according to charging policy information, and the charging policy information is for example charging information in the PCC rule.

In this embodiment, the charging correction for the dropped data packets is implemented by using at least one charging method of the online charging, the offline charging, and the integrating charging, thereby improving the flexibility of the charging processing.

FIG. 4 is a flowchart of a charging processing method shown according to an exemplary embodiment. As shown in FIG. 4, the charging processing method is performed by a PCF entity and includes step 301.

At step 301, a charging offset indication is sent to an SMF entity, where the charging offset indication indicates whether an access network node is to perform a charging correction for one or more dropped data packets.

In some examples, the one or more dropped data packets may include: one or more PDU sets initiatively dropped by the access network node and/or one or more data packets, in a PDU set, initiatively dropped by the access network node.

For example, for a service data flow in the downlink direction, an RAN node initiatively drops remaining data packets in the data set and/or data packets in the related data set based on QoS characteristic or requirement matching between data units in a data set and/or between data sets.

In some examples, the one or more dropped data packets may include at least one of: a PDU set with a priority lower than a specified priority, a PDU set with an importance lower than a specified importance, a data packet with the priority lower than a preset priority in the PDU set, or a data packet with an importance lower than the preset importance in the PDU set.

In some examples, when a value of the charging offset indication is a first value, it indicates that the charging correction for the dropped data packets needs or is allowed to be performed. When a value of the charging offset indication is a second value, it indicates that the charging correction for the dropped data packets does not need or is not allowed to be performed.

For example, the first value is “charging offset”, and the second value is “non-offset”. For another example, the first value is 1, and the second value is 0.

In some other examples, the charging offset indication may include a data volume threshold, and the data volume threshold is for determining whether the charging correction for the dropped data packets is to be performed.

For example, when the volume of the dropped data packets is greater than the data volume threshold, it indicates that the charging correction for the dropped data packets needs or is allowed to be performed. When the volume of the dropped data packets is less than or equal to the data volume threshold, it indicates that the charging correction for the dropped data packets does not need or is not allowed to be performed.

In some examples, the charging offset indication may be generated by the PCF entity according to subscription information or a local policy.

The PCF entity may generate the charging offset indication according to the subscription information or the local policy, and send the charging offset indication to the access network node via the SMF entity.

In some examples, the PCF entity may send the PCC rule carrying the charging offset indication to the SMF entity.

In some examples, the PCF entity may send the PCC rule carrying the charging offset indication to the SMF entity in an establishment or modification procedure of a PDU session.

In some examples, the PCC rule includes a related QoS parameter and charging information of the PDU set. The charging offset indication may be carried in the charging information.

In some examples, in the modification procedure of the PDU session, the PCF entity may generate the PCC rule according to a request message from the AF entity.

In some examples, the PCF entity receives the request message sent by the AF entity, where the request message includes QoS parameters of each PDU set in the QoS flow and parameters on frame identification.

If the AF entity may directly interact with the PCF entity, the PCF entity may receive the request message directly sent by the AF entity. If the AF entity needs to interact with the PCF entity via a network exposure function (NEF) entity, the PCF entity may receive the request message that is from the AF entity and forwarded by the NEF entity.

The QoS parameters of each PDU set in the QoS flow may include:
a PDU set handling indication, indicating whether PDU set based handling is activated to a QoS flow; where the indication may be implicitly indicated via other PDU set related information provided by the AF entity;
whether all PDUs are needed for the usage of PDU set by the application layer;
a PDU set delay budget; and
a PDU set error rate;
where the parameters on the frame identification include burst periodicity.

In the charging processing method provided by the embodiment of the present disclosure, the PCF entity sends the charging offset indication to the SMF entity, so that the SMF entity may send the charging offset indication to the access network node, which may thereby trigger that the access network node determines whether the charging correction for the dropped data packets is to be performed according to the charging offset indication, and can improve the accuracy of the charging result.

In an embodiment, accuracy the charging offset indication is carried in charging information included in a PCC rule; and/or
the charging offset indication is carried in related policy information of a PDU session; and/or
the charging offset indication is carried in related policy information of a PDU set.

In some examples, the PCC rule includes a related QoS parameter and charging information of the PDU set, and the charging offset indication may be carried in the charging information.

In some other examples, the related policy information of the PDU session includes a charging parameter of the PDU session, and the charging offset indication may be carried in the charging parameter included in the related policy information of the PDU session.

In some still other examples, the related policy information of the PDU set includes the charging parameter, and the charging offset indication may be carried in the charging parameter included in the related policy information of the PDU set.

In some examples, both the related policy information of the PDU session and the related policy information of the PDU set may be included in the PCC rule.

In some examples, the PCC rule may be associated with a user identifier of the terminal.

In some examples, the PCC rule is provided by the PCF entity to the SMF entity.

In an embodiment, the one or more dropped data packets include: one or more PDU sets initiatively dropped by the access network node and/or one or more data packets in a PDU set initiatively dropped by the access network node in PDU set based QoS handling.

For a service data flow in a downlink direction, the access network node initiatively drops remaining data packets in the data set and/or data packets in the related data set, based on QoS characteristic or requirement matching between data units in a PDU set and/or between PDU sets (for example, dependency relationships between data units in a PDU set, dependency relationships between PDU sets, importances/priorities of the data units in the PDU set, importances/priorities of the PDU sets, etc.).

In an embodiment, the one or more initiatively dropped PDU sets include at least one of:
a PDU set with a transmission delay time exceeding a PDU set transmission delay budget;
a PDU set with a transmission error rate exceeding a PDU set transmission error rate threshold;
a second PDU set that is initiatively dropped based on a transmission failure of a first PDU set;
a PDU set with a priority lower than a preset priority;
a PDU set depending on other PDU sets; or
a PDU set with an importance lower than a preset importance.

In an embodiment, the first PDU set and the second PDU set have a relationship including at least one of:
the second PDU set depending on the first PDU set;
an importance of the second PDU set being lower than an importance of the first PDU set; or
a priority of the second PDU set being lower than a priority of the first PDU set. The PDU set transmission delay budget, the PDU set transmission error rate threshold, the dependency relationship between PDU sets, and the importance of the PDU set may all be included in related QoS parameters of the PDU sets.

The PDU set that is failure-transmitted may be a PDU set that is not successfully received by the access network node within a set duration.

In an embodiment, the one or more initiatively dropped data packets include at least one of:
a data packet with a transmission delay time exceeding a data packet transmission delay budget;
a data packet with a transmission error rate exceeding a data packet transmission error rate threshold;
a second data packet that is initiatively dropped based on a transmission failure of a first data packet;
a data packet with a priority lower than a preset priority;
a data packet depending on other data packets; or
a data packet with an importance lower than a preset importance.

In an embodiment, the first data packet and the second data packet belong to a same PDU set, and have a relationship including at least one of:
the second data packet depending on the first data packet;
an importance of the second data packet being lower than an importance of the first data packet; or
a priority of the second data packet being lower than a priority of the first data packet.

The data packet transmission delay budget, the data packet transmission error rate threshold, the dependency relationship between the data packets in the PDU set, and the importances of the data packets in the PDU set may all be included in related QoS parameters of the PDU sets.

The data packet that is failure-transmitted may be a data packet in a PDU set that is not successfully received by the access network node within a set duration.

In an embodiment, a data flow for the one or more dropped data packets is an XR service data flow or a multimodal data service data flow.

The data flow is a service data flow provided by the core network to the terminal via the access network node in response to a service request of the terminal.

In this embodiment, both the XR service data flow and the multimodal data service data flow have the characteristics of high bandwidth, low latency, and high reliability requirements. For downlink transmission of these types of service data flows, when the access network node matches the QoS or requirement for a data unit and/or a data set in the data flow, the access network node initiatively drops a data packet, to determine, through a charging offset indication, whether the charging correction for the dropped data packet is to be performed, which can improve the accuracy of the charging result.

In an embodiment, sending the charging offset indication to the SMF entity includes:
sending, in an establishment or modification procedure of a PDU session, the charging offset indication to the SMF entity.

In this embodiment, in the establishment or modification procedure of the PDU session, the PCF entity may send the charging offset indication to the SMF entity, by carrying the charging offset indication in at least one of the PCC rule, the related policy of the PDU session, and/or the related policy of the PDU set.

In an embodiment, one or more charging scenarios for the charging correction include at least one of:
a scenario of charging based on the volume;
a scenario of charging based on combination of the volume and a time;
a scenario of charging based on combination of the volume and an event; or
a scenario of charging based on combination of the volume, the time, and the event.

When the charging is performed based on the combination of the volume and the time, the charging may be performed according to the volume of the service data flow and time information (the time information includes for example a starting moment and an ending moment).

When the charging is performed based on the combination of the volume and the event, the charging may be performed according to the volume of the service data flow and event information (the event information is for example a service type of the service data flow).

In some examples, the charging scenarios for the charging correction may be determined according to charging policy information, and the charging policy information is for example charging information in the PCC rule.

In this embodiment, flexibility of charging processing is improved, by providing a plurality of charging scenarios for the charging correction.

In an embodiment, one or more charging methods for the charging correction include at least one of:
online charging;
offline charging; or integrating charging.

The integrating charging refers to charging in which the online charging and the offline charging are integrated.

In some examples, the charging methods for the charging correction may be determined according to charging policy information, and the charging policy information is for example charging information in the PCC rule.

In this embodiment, the charging correction for the dropped data packets is implemented by using at least one charging method of the online charging, the offline charging, and the integrating charging, thereby improving the flexibility of the charging processing.

FIG. 5 is a flowchart of a charging processing method shown according to an exemplary embodiment. As shown in FIG. 5, the charging processing method is performed by an SMF entity and includes step 402.

At step 402, a charging offset indication is sent to an access network node, where the charging offset indication indicates whether the access network node is to perform a charging correction for one or more dropped data packets.

In some examples, the one or more dropped data packets may include: one or more PDU sets initiatively dropped by the access network node and/or one or more data packets, in a PDU set, initiatively dropped by the access network node.

For example, for a service data flow in the downlink direction, an RAN node initiatively drops remaining data packets in the data set and/or data packets in the related data set based on QoS characteristic or requirement matching between data units in a data set and/or between data sets.

In some examples, the one or more dropped data packets may include at least one of: a PDU set with a priority lower than a specified priority, a PDU set with an importance lower than a specified importance, a data packet with the priority lower than a preset priority in the PDU set, or a data packet with an importance lower than the preset importance in the PDU set.

In some examples, when a value of the charging offset indication is a first value, it indicates that the charging correction for the dropped data packets needs or is allowed to be performed. When a value of the charging offset indication is a second value, it indicates that the charging correction for the dropped data packets does not need or is not allowed to be performed.

For example, the first value is “charging offset”, and the second value is “non-offset”. For another example, the first value is 1, and the second value is 0.

In some other examples, the charging offset indication may include a data volume threshold, and the data volume threshold is for determining whether the charging correction for the dropped data packets is to be performed.

For example, when the volume of the dropped data packets is greater than the data volume threshold, it indicates that the charging correction for the dropped data packets needs or is allowed to be performed. When the volume of the dropped data packets is less than or equal to the data volume threshold, it indicates that the charging correction for the dropped data packets does not need or is not allowed to be performed.

In some examples, the charging offset indication may be generated by the PCF entity according to subscription information or a local policy.

The PCF entity may generate the charging offset indication according to the subscription information or the local policy, and send the charging offset indication to the access network node via the SMF entity.

In the charging processing method provided by the embodiment of the present disclosure, the charging offset indication is sent to the access network node, so that the access network node determines whether the charging correction for the dropped data packets is to be performed according to the charging offset indication, which can improve the accuracy of the charging result.

In an embodiment, accuracy the charging offset indication is carried in charging information included in a PCC rule; and/or
the charging offset indication is carried in related policy information of a PDU session; and/or
the charging offset indication is carried in related policy information of a PDU set.

In some examples, the PCC rule includes a related QoS parameter and charging information of the PDU set, and the charging offset indication may be carried in the charging information.

In some other examples, the related policy information of the PDU session includes a charging parameter of the PDU session, and the charging offset indication may be carried in the charging parameter included in the related policy information of the PDU session.

In some still other examples, the related policy information of the PDU set includes the charging parameter, and the charging offset indication may be carried in the charging parameter included in the related policy information of the PDU set.

In some examples, both the related policy information of the PDU session and the related policy information of the PDU set may be included in the PCC rule.

In some examples, the PCC rule may be associated with a user identifier of the terminal.

In some examples, the PCC rule is provided by the PCF entity to the SMF entity.

In an embodiment, the one or more dropped data packets include: one or more PDU sets initiatively dropped by the access network node and/or one or more data packets in a PDU set initiatively dropped by the access network node in PDU set based QoS handling.

For a service data flow in a downlink direction, the access network node initiatively drops remaining data packets in the data set and/or data packets in the related data set, based on QoS characteristic or requirement matching between data units in a PDU set and/or between PDU sets (for example, dependency relationships between data units in a PDU set, dependency relationships between PDU sets, importances/priorities of the data units in the PDU set, importances/priorities of the PDU sets, etc.).

In an embodiment, the one or more initiatively dropped PDU sets include at least one of:
a PDU set with a transmission delay time exceeding a PDU set transmission delay budget;
a PDU set with a transmission error rate exceeding a PDU set transmission error rate threshold;
a second PDU set that is initiatively dropped based on a transmission failure of a first PDU set;
a PDU set with a priority lower than a preset priority;
a PDU set depending on other PDU sets; or
a PDU set with an importance lower than a preset importance.

In an embodiment, the first PDU set and the second PDU set have a relationship including at least one of:
the second PDU set depending on the first PDU set;
an importance of the second PDU set being lower than an importance of the first PDU set; or
a priority of the second PDU set being lower than a priority of the first PDU set.

The PDU set transmission delay budget, the PDU set transmission error rate threshold, the dependency relationship between PDU sets, and the importance of the PDU set may all be included in related QoS parameters of the PDU sets.

The PDU set that is failure-transmitted may be a PDU set that is not successfully received by the access network node within a set duration.

In an embodiment, the one or more initiatively dropped data packets include at least one of:
a data packet with a transmission delay time exceeding a data packet transmission delay budget;
a data packet with a transmission error rate exceeding a data packet transmission error rate threshold;
a second data packet that is initiatively dropped based on a transmission failure of a first data packet;
a data packet with a priority lower than a preset priority;
a data packet depending on other data packets; or
a data packet with an importance lower than a preset importance.

In an embodiment, the first data packet and the second data packet belong to a same PDU set, and have a relationship including at least one of:
the second data packet depending on the first data packet;
an importance of the second data packet being lower than an importance of the first data packet; or
a priority of the second data packet being lower than a priority of the first data packet.

The data packet transmission delay budget, the data packet transmission error rate threshold, the dependency relationship between the data packets in the PDU set, and the importances of the data packets in the PDU set may all be included in related QoS parameters of the PDU sets.

The data packet that is failure-transmitted may be a data packet in a PDU set that is not successfully received by the access network node within a set duration.

In an embodiment, a data flow for the one or more dropped data packets is an XR service data flow or a multimodal data service data flow.

The data flow is a service data flow provided by the core network to the terminal via the access network node in response to a service request of the terminal.

In this embodiment, both the XR service data flow and the multimodal data service data flow have the characteristics of high bandwidth, low latency, and high reliability requirements. For downlink transmission of these types of service data flows, when the access network node matches the QoS or requirement for a data unit and/or a data set in the data flow, the access network node initiatively drops a data packet, to determine, through a charging offset indication, whether the charging correction for the dropped data packet is to be performed, which can improve the accuracy of the charging result.

In an embodiment, as shown in FIG. 6, the method further includes step 401.

At step 401, the charging offset indication sent by a PCF entity is received.

In some examples, receiving the charging offset indication sent by the PCF entity includes at least one of:
receiving a PCC rule carrying the charging offset indication sent by the PCF entity;
receiving related policy information of a PDU session carrying the charging offset indication sent by the PCF entity; or
receiving related policy information of a PDU set carrying the charging offset indication sent by the PCF entity.

In some examples, the PCC rule includes a related QoS parameter and charging information of the PDU set. The charging offset indication may be carried in the charging information.

In an embodiment, receiving the charging offset indication sent by the PCF entity includes:
receiving, in an establishment or modification procedure of a PDU session, the charging offset indication sent by the PCF entity.

In the establishment procedure of the PDU session, the SMF entity may send an SM policy association establishment request to the PCF entity, to request the PCF entity to provide the PCC rule. After the PCF entity receives the SM policy association establishment request sent by the SMF entity, the PCF entity adds the charging offset indication to the PCC rule and sends the PCC rule to the SMF entity.

In the modification procedure of the PDU session, the SMF entity may send an SM policy association modification request to the PCF entity, to request the PCF entity to provide the PCC rule. After the PCF entity receives the SM policy association modification request sent by the SMF entity, the PCF entity adds the charging offset indication to the PCC rule and sends the PCC rule to the SMF entity.

In an embodiment, the method further includes:
sending the charging offset indication to a UPF entity.

In an embodiment, one or more charging scenarios for the charging correction include at least one of:
a scenario of charging based on the volume;
a scenario of charging based on combination of the volume and a time;
a scenario of charging based on combination of the volume and an event; or
a scenario of charging based on combination of the volume, the time, and the event.

When the charging is performed based on the combination of the volume and the time, the charging may be performed according to the volume of the service data flow and time information (the time information includes for example a starting moment and an ending moment).

When the charging is performed based on the combination of the volume and the event, the charging may be performed according to the volume of the service data flow and event information (the event information is for example a service type of the service data flow).

In some examples, the charging scenarios for the charging correction may be determined according to charging policy information, and the charging policy information is for example charging information in the PCC rule.

In this embodiment, flexibility of charging processing is improved, by providing a plurality of charging scenarios for the charging correction.

In an embodiment, one or more charging methods for the charging correction include at least one of:
online charging;
offline charging; or
integrating charging.

The integrating charging refers to charging in which the online charging and the offline charging are integrated.

In some examples, the charging methods for the charging correction may be determined according to charging policy information, and the charging policy information is for example charging information in the PCC rule.

In this embodiment, the charging correction for the dropped data packets is implemented by using at least one charging method of the online charging, the offline charging, and the integrating charging, thereby improving the flexibility of the charging processing.

To further explain any embodiment of the present disclosure, several specific embodiments are provided below.

In the charging processing method provided by the embodiment of the present disclosure, PDU set based policy and charging control may be performed, in the establishment or modification procedure of the PDU session.

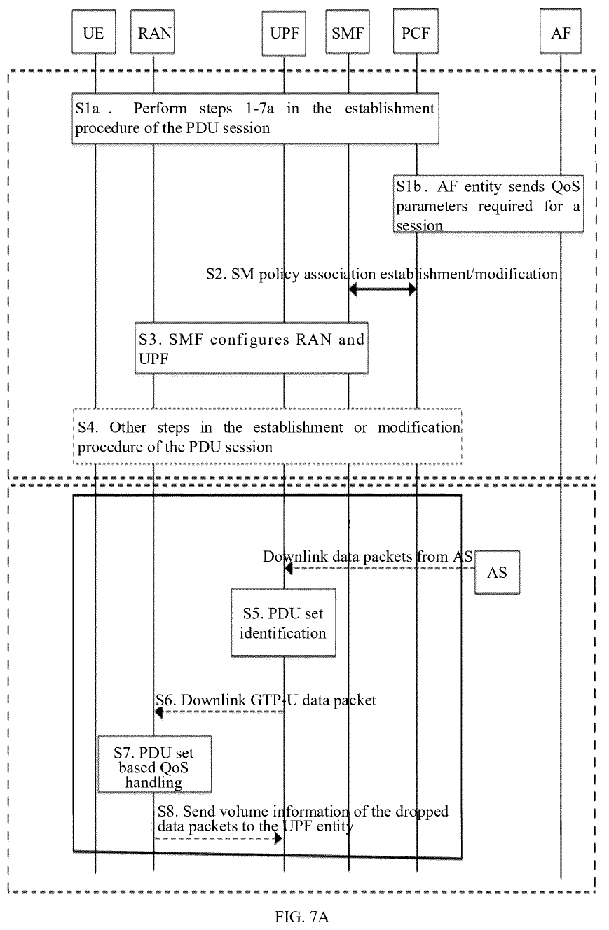

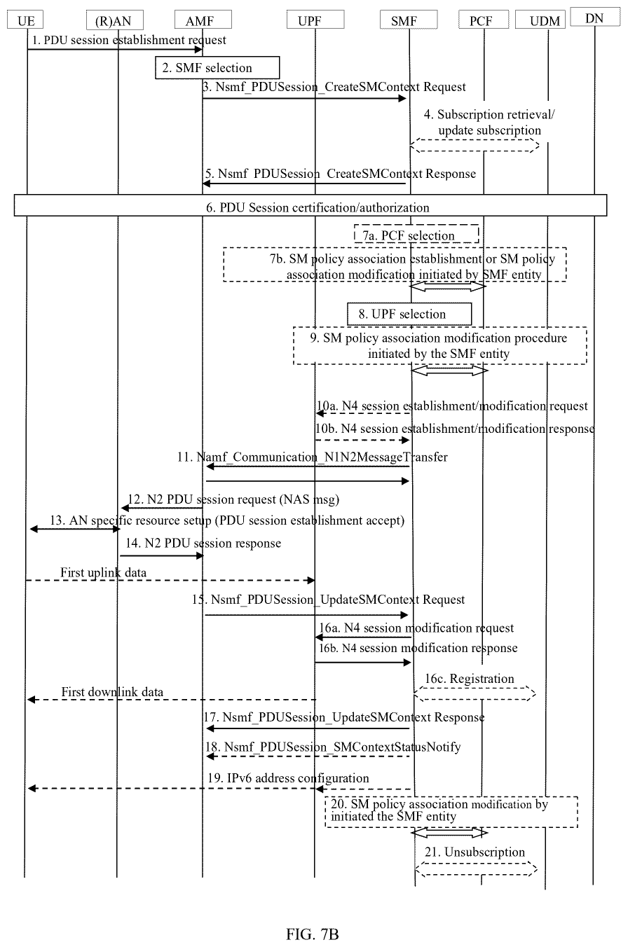

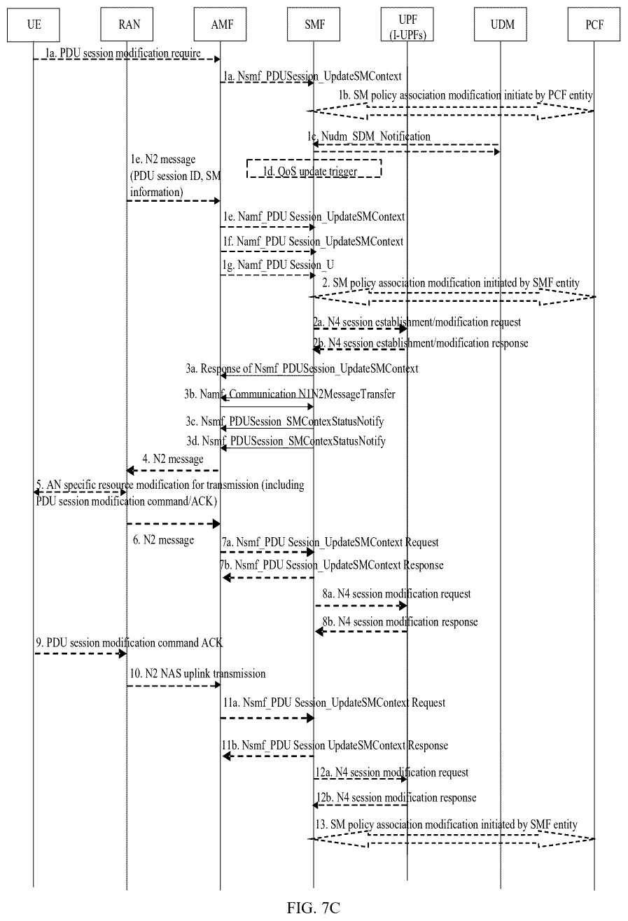

As shown in FIG. 7A, the method includes the following steps S1a-S8.

At step S1a, steps 1-7a (referring to FIG. 7B) in the establishment procedure of the PDU session are performed.

At step S1b, the AF entity may send information to the PCF entity via Nnef_AFsessionWithQoS_Create request. The information includes QoS parameters of each PDU set in the QoS flow and parameters on frame identification. The AF entity may also provide the information to the 5GS prior to the establishment of the PDU session.

The QoS parameters of each PDU set in the QoS flow may include:
a PDU set handling indication, indicating whether PDU set based handling is activated to a QoS flow; where the indication may be implicitly indicated via other PDU set related information provided by the AF entity;
whether all PDUs are needed for the usage of PDU set by the application layer;
a PDU set delay budget; and
a PDU set error rate;
where the parameters on the frame identification include burst periodicity.

At step S2, the PCF entity generates the appropriate PCC rule, which includes related QoS parameters of the PDU set. The PCF entity sends the PCC rule to SMF entity.

The PCC rule carries the charging offset indication while the PDU set based QoS handling, and the charging offset indication is received by the RAN to determine whether the charging correction for corresponding dropped data packets is to be performed.

The charging offset indication while the PDU set based QoS handling indicates whether charging correction for the dropped data packets in the PDU set based QoS handling is needed or allowed. Values of the charging offset indication include charging offset or non-offset. In case of the charging offset, the volume of the dropped data packets in the PDU set based QoS handling is counted and reported, and the charging accuracy correction is performed for the dropped volume. In case of the charging non-offset, the volume of the dropped data packets in the PDU set based QoS handling is not counted and reported, or after the volume of the corresponding dropped data packets is counted and reported, the charging accuracy correction is not performed for the volume.

The charging offset indication may be sent by being carried in:
the charging information in the PCC rule; and/or
the charging parameter in the related policy information of the PDU session; and/or
the charging parameter in the related policy information of the PDU set.

One or more related QoS parameters of the PDU set are new QoS parameters of the PDU set based QoS handling in the 5GS, and may include at least one of:
a PDU set delay budget (PSDB);
a PDU set error rate (PSER);
whether all PDUs are needed for the usage of PDU set by the application layer;
whether the PDU set is dropped in the case of exceeding the PSDB; or
a priority of a PDU set, where priorities of all PDU sets are the same, or each of the priorities of the PDU sets is different (that is, same as importances of the PDU sets).

This step may be completed in step 7b in the establishment procedure of the PDU session, or in step 1b in the modification procedure of the PDU session.

If this step is triggered by the step 1b, the PCF entity generates the PCC rule according to the information provided by the AF entity.

At step S3, the SMF entity generates a QoS profile and an N4 rule according to the PCC rule from the PCF entity. The SMF entity sends the N4 rule to the UPF entity and sends the QoS profile to the RAN node via the AMF entity. The N4 rule includes the charging information of the PDU set. This step may be completed in steps 8-15 in the establishment procedure of the PDU session, or in steps 2-7 in the modification procedure of the PDU session.

At step S4, the remaining steps may be based on the establishment or modification procedure of the session in the existing technology.

At step S5, the UPF entity identifies related information according to the received N4 rule or the local configuration of the UPF entity, and performs the PDU set based QoS handling according to the N4 rule. The UPF entity stores the charging offset indication, and if the UPF entity needs to cooperate with the RAN to perform the charging correction, the UPF entity may cooperate with the RAN to perform the charging correction for corresponding dropped data packets.

The UPF entity identifies PDUs belonging to a PDU set and the following information of each PDU set:
information of intra-PDU set handling, including at least one of the following parameters:
a PDU set sequence number (SN); for example, the QoS flow is identified using QoS flow ID and each PDU set in the QoS flow is identified using the PDU set SN; and a QoS flow may be used to transmit one or more PDU sets;
a starting PDU and/or an ending PDU of the PDU set;
a PDU SN in a PDU set;
the number of PDUs in a PDU set; or
information of inter-PDU set handling, including at least one of the following parameters:
an importance of the PDU set; or
a correlation of the PDU set.

The UPF entity identifies the related information via corresponding methods/mechanisms, as follows:
an option 1: by matching an RTP (real-time transport protocol) or SRTP (secure real-time transport protocol) header and payload;
an option 2: by a new RTP extension header;
an option 3: by information provided by the AS entity in an N6 encapsulation header, for example, GTP-U (user plane part of GTP);
an option 4: by detection based on traffic characteristics;
an option 5: by non-standardized mechanisms UPF implementation.

At step S6, the UPF entity sends the related information of the PDU set to the RAN.

For the importance of the PDU set, optionally:
an option 1: the UPF entity classifies DL traffics into different QoS flows according to the importance of the PDU set;
an option 2: the UPF entity classifies the DL traffics into different sub-QoS flows according to the importance of the PDU set; and
an option 3: the UPF entity adds the importance of the PDU set into the GTP-U header.

For related information of the other PDU sets in the step S5, the UPF entity adds the related information to the GTP-U header.

At step S7, the RAN performs the PDU set based QoS handling based on the related information of the PDU set received in step S6.

The RAN determines, according to the received charging offset indication, whether the charging correction for corresponding dropped data packets is to be performed.

The dropped data packets include: an initiatively dropped PDU set and/or an initiatively dropped data packet in the PDU set.
1) Reasons for dropping the PDU set includes, for example: exceeding the PDU set delay budget (PSDB), exceeding the PDU set error rate, the transmission failure of the depended PDU set, or the transmission failure of the important PDU set.
2) Reasons for dropping the data packet in the PDU set includes: exceeding the data packet delay budget (PDB), exceeding the data packet error rate, the transmission failure of the depended data packet in the PDU set, or the transmission failure of the data packet with a high importance in the PDU set.

At step S8, when determining that charging correction for the dropped data packets is performed, the RAN sends volume information of the dropped data packets and/or the data packet with a drop sign to the UPF entity.

One or more charging scenarios applicable by the charging correction include at least one of: charging based on the volume; charging based on combination of the volume and a time; charging based on combination of the volume and an event; or charging based on combination of the volume, the time, and the event.

One or more charging methods applicable by the charging correction include at least one of: online charging, offline charging, or integrating charging including online and offline.

In the charging processing method provided by the embodiment of the present disclosure, the PDU set based policy and charging control may be performed, in the establishment procedure of the PDU session.

As shown in FIG. 7B, the method includes the following steps.

At step 7b, the SMF entity performs an SM policy association establishment procedure, to establish an SM policy association with the PCF entity and obtain a default PCC rule of the PDU session. A GPSI (general public subscriber identifier), a PVS (provisioning services)-FQDN (fully qualified domain name) or a PVS IP address (Internet protocol address), and an onboarding indication shall be included if available at SMF entity in the case of an ON-SNPN (stand-alone non-public network (NPN)).

If the request type in step 3 shown in FIG. 7B indicates “existing PDU session”, the SMF entity may provide information on the policy control request trigger conditions that have been met by an SM policy association modification procedure initiated by the SMF entity. The PCF entity may provide the policy information to the SMF entity.

The PCF entity generates a PCC rule, and sends the PCC rule to SMF entity. The PCC rule includes the related QoS parameter and charging information of the PDU set. The PCC rule includes the charging offset indication while the PDU set based QoS handling, and the charging offset indication is received by the RAN to determine whether the charging correction for corresponding dropped data packets is to be performed.

The PCF entity generates an appropriate PCC rule, which may include the related QoS parameter and the charging information of the PDU set. The PCF entity sends the PCC rule to the SMF entity.

The charging offset indication while the PDU set based QoS handling indicates whether charging correction for the dropped data packets in the PDU set based QoS handling is needed/allowed. Values of the charging offset indication include charging offset or non-offset. In case of the charging offset, the volume of the dropped data packets in the PDU set based QoS handling is counted and reported, and the charging accuracy correction is performed for the dropped volume. In case of the charging non-offset, the volume of the dropped data packets in the PDU set based QoS handling is not counted and reported, or after the volume of the corresponding dropped data packets is counted and reported, the charging accuracy correction is not performed for the volume.

The charging offset indication may be sent by being carried in:
the charging information in the PCC rule; and/or
the charging parameter in the related policy information of the PDU session; and/or
the charging parameter in the related policy information of the PDU set.

One or more related QoS parameters of the PDU set are new QoS parameters of the PDU set based QoS handling in the 5GS, and may include at least one of:
a PDU set delay budget (PSDB);
a PDU set error rate (PSER);
whether all PDUs are needed for the usage of PDU set by the application layer;
whether the PDU set is dropped in the case of exceeding the PSDB; or
a priority of a PDU set, where priorities of all PDU sets are the same, or each of the priorities of the PDU sets is different (that is, same as importances of the PDU sets).

At steps 8-15, the SMF entity generates a QoS profile and an N4 rule according to the PCC rule from the PCF entity. The SMF entity sends the N4 rule to the UPF entity and sends the QoS profile to the RAN node via the AMF entity. The N4 rule includes the charging information of the PDU set.

The remaining steps include:
the remaining steps in the establishment procedure of the session, which may be based on the establishment procedure of the session in the existing technologies.

The related QoS parameter and charging information of the PDU set of the UPF entity and the RAN are the same as the information in the steps S5-S8 shown in FIG. 7A, and will be not repeated herein.

In the charging processing method provided by the embodiment of the present disclosure, the PDU set based policy and charging control may be performed in the modification procedure of the PDU session. The modification of the PDU session may be initiated by the UE or the network.

As shown in FIG. 7C, the method includes the following steps.

At step 1b, the PCF entity initiates the SM policy association modification. The PCF entity performs an SM policy association modification procedure initiated by the PCF entity, and notifies the SMF entity of the modification of the policy. This may be for example triggered by a policy decision or an application function (AF) request, for example, an AF influence on traffic routing or AF to provide a port management information container.

The PCF entity generates the PCC rule and provides the PCC rule to the SMF entity. The PCC rule includes a related QoS parameter and charging information of the PDU set. The PCC rule includes the charging offset indication while the PDU set based QoS handling, and the charging offset indication is received by the RAN to determine whether the charging correction for corresponding dropped data packets is to be performed.

The PCF entity generates an appropriate PCC rule, which may include the related QoS parameter of the PDU set. The PCF entity sends the PCC rule to the SMF entity.

The charging offset indication while the PDU set based QoS handling indicates whether the charging correction for the dropped data packets in the PDU set based QoS handling is needed/allowed. Values of the charging offset indication include charging offset or non-offset. In case of the charging offset, the volume of the dropped data packets in the PDU set based QoS handling is counted and reported, and the charging accuracy correction is performed for the dropped volume. In case of the charging non-offset, the volume of the dropped data packets in the PDU set based QoS handling is not counted and reported, or after the volume of the corresponding dropped data packets is counted and reported, the charging accuracy correction is not performed for the volume.

The charging offset indication may be sent by being carried in:
the charging information in the PCC rule; and/or
the charging parameter in the related policy information of the PDU session; and/or
the charging parameter in the related policy information of the PDU set.

One or more related QoS parameters of the PDU set are new QoS parameters of the PDU set based QoS handling in the 5GS, and may include at least one of:
a PDU set delay budget (PSDB);
a PDU set error rate (PSER);
whether all PDUs are needed for the usage of PDU set by the application layer;
whether the PDU set is dropped in the case of exceeding the PSDB; or
a priority of a PDU set, where priorities of all PDU sets are the same, or each of the priorities of the PDU sets is different (that is, same as importances of the PDU sets).

At steps 2-7, the SMF entity generates a QoS profile and an N4 rule according to the PCC rule from the PCF entity.

The SMF entity sends the N4 rule to the UPF entity and sends the QoS profile to the RAN node via the AMF entity. The N4 rule includes the charging information of the PDU set.

The remaining steps include:
the remaining steps in the modification procedure of the session, which may be based on the modification procedure of the session in the existing technologies.

The related QoS parameter and charging information of the PDU set of the UPF entity and the RAN are the same as the information in the steps S5-S8 shown in FIG. 7A, and will be not repeated herein.

The technical solutions provided by the embodiments of the present disclosure support charging corresponding to QoS enhancement of XR service data flows. After a UPF entity performs charging statistics and reporting for downlink data, an RAN initiatively drops remaining data packets in the data sets and/or data packets in related data sets based on QoS characteristic/requirement matching between data units in a data set and/or between data sets, which supports the charging correction in a PDU set scenario, and implements accurate charging.

The following is an apparatus embodiment of the present disclosure, which may be used to perform the corresponding method embodiments of the present disclosure. Details not disclosed in the apparatus embodiments of the present disclosure refer to corresponding method embodiments of the present disclosure.

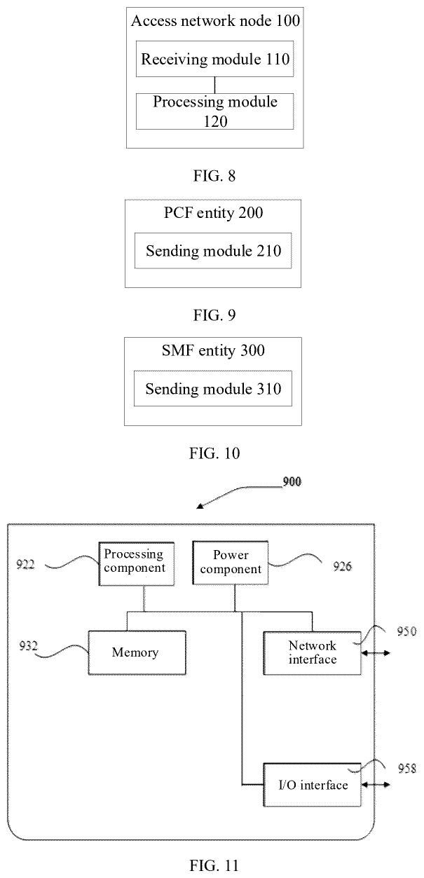

FIG. 8 is a structural diagram of an access network node shown according to an exemplary embodiment. As shown in FIG. 8, the access network node 100 includes:
a receiving module 110, configured to receive a charging offset indication sent by an SMF entity; and
a processing module 120, configured to determine, according to the charging offset indication, whether a charging correction for one or more dropped data packets is to be performed.

In an embodiment, accuracy the charging offset indication is carried in charging information included in a PCC rule; and/or
the charging offset indication is carried in related policy information of a PDU session; and/or
the charging offset indication is carried in related policy information of a PDU set.

In an embodiment, the one or more dropped data packets include: one or more PDU sets initiatively dropped by the access network node and/or one or more data packets in a PDU set initiatively dropped by the access network node in PDU set based QoS handling.

In an embodiment, the one or more initiatively dropped PDU sets include at least one of:
a PDU set with a transmission delay time exceeding a PDU set transmission delay budget;
a PDU set with a transmission error rate exceeding a PDU set transmission error rate threshold;
a second PDU set that is initiatively dropped based on a transmission failure of a first PDU set;
a PDU set with a priority lower than a preset priority;
a PDU set depending on other PDU sets; or
a PDU set with an importance lower than a preset importance.

In an embodiment, the first PDU set and the second PDU set have a relationship including at least one of:
the second PDU set depending on the first PDU set;
an importance of the second PDU set being lower than an importance of the first PDU set; or
a priority of the second PDU set being lower than a priority of the first PDU set.

In an embodiment, the one or more initiatively dropped data packets include at least one of:
a data packet with a transmission delay time exceeding a data packet transmission delay budget;
a data packet with a transmission error rate exceeding a data packet transmission error rate threshold;
a second data packet that is initiatively dropped based on a transmission failure of a first data packet;
a data packet with a priority lower than a preset priority;
a data packet depending on other data packets; or
a data packet with an importance lower than a preset importance.

In an embodiment, the first data packet and the second data packet belong to a same PDU set, and have a relationship including at least one of:
the second data packet depending on the first data packet;
an importance of the second data packet being lower than an importance of the first data packet; or
a priority of the second data packet being lower than a priority of the first data packet.

In an embodiment, a data flow for the one or more dropped data packets is an XR service data flow or a multimodal data service data flow.

In an embodiment, the processing module is configured to determine that the charging correction for the one or more dropped data packets is performed; and
the access network node 100 further includes:
a sending module, configured to send volume information of the one or more dropped data packets and/or a data packet with a drop sign to a UPF entity.

In an embodiment, one or more charging scenarios for the charging correction include at least one of:
a scenario of charging based on the volume; a scenario of charging based on combination of the volume and a time;
a scenario of charging based on combination of the volume and an event; or
a scenario of charging based on combination of the volume, the time, and the event.

In an embodiment, one or more charging methods for the charging correction include at least one of:
online charging;
offline charging; or
integrating charging.

FIG. 9 is a structural diagram of a PCF entity shown according to an exemplary embodiment. As shown in FIG. 9, the PCF entity 200 includes:

a sending module 210, configured to send a charging offset indication to an SMF entity, where the charging offset indication indicates whether an access network node is to perform a charging correction for one or more dropped data packets.

In an embodiment, accuracy the charging offset indication is carried in charging information included in a PCC rule; and/or
the charging offset indication is carried in related policy information of a PDU session; and/or
the charging offset indication is carried in related policy information of a PDU set.

In an embodiment, the one or more dropped data packets include: one or more PDU sets initiatively dropped by the access network node and/or one or more data packets in a PDU set initiatively dropped by the access network node in PDU set based QoS handling.

In an embodiment, the one or more initiatively dropped PDU sets include at least one of:
a PDU set with a transmission delay time exceeding a PDU set transmission delay budget;
a PDU set with a transmission error rate exceeding a PDU set transmission error rate threshold;
a second PDU set that is initiatively dropped based on a transmission failure of a first PDU set;
a PDU set with a priority lower than a preset priority;
a PDU set depending on other PDU sets; or
a PDU set with an importance lower than a preset importance.

In an embodiment, the first PDU set and the second PDU set have a relationship including at least one of:
the second PDU set depending on the first PDU set;
an importance of the second PDU set being lower than an importance of the first PDU set; or
a priority of the second PDU set being lower than a priority of the first PDU set.

In an embodiment, the one or more initiatively dropped data packets include at least one of:
a data packet with a transmission delay time exceeding a data packet transmission delay budget;
a data packet with a transmission error rate exceeding a data packet transmission error rate threshold;
a second data packet that is initiatively dropped based on a transmission failure of a first data packet;
a data packet with a priority lower than a preset priority;
a data packet depending on other data packets; or
a data packet with an importance lower than a preset importance.

In an embodiment, the first data packet and the second data packet belong to a same PDU set, and have a relationship including at least one of:
the second data packet depending on the first data packet;
an importance of the second data packet being lower than an importance of the first data packet; or
a priority of the second data packet being lower than a priority of the first data packet. In an embodiment, a data flow for the one or more dropped data packets is an XR service data flow or a multimodal data service data flow.

In an embodiment, the sending module is configured to:
send, in an establishment or modification procedure of a PDU session, the charging offset indication to the SMF entity.

In an embodiment, one or more charging scenarios for the charging correction include at least one of:
a scenario of charging based on the volume;
a scenario of charging based on combination of the volume and a time;
a scenario of charging based on combination of the volume and an event; or
a scenario of charging based on combination of the volume, the time, and the event.

In an embodiment, one or more charging methods for the charging correction include at least one of:
online charging;
offline charging; or
integrating charging.

FIG. 10 is a structural diagram of an SMF entity shown according to an exemplary embodiment. As shown in FIG. 10, the SMF entity 300 includes:
a sending module 310, configured to send a charging offset indication to an access network node, where the charging offset indication indicates whether the access network node is to perform a charging correction for one or more dropped data packets.

In an embodiment, accuracy the charging offset indication is carried in charging information included in a PCC rule; and/or
the charging offset indication is carried in related policy information of a PDU session; and/or
the charging offset indication is carried in related policy information of a PDU set.

In an embodiment, the one or more dropped data packets include: one or more PDU sets initiatively dropped by the access network node and/or one or more data packets in a PDU set initiatively dropped by the access network node in PDU set based QoS handling.

In an embodiment, the one or more initiatively dropped PDU sets include at least one of:
a PDU set with a transmission delay time exceeding a PDU set transmission delay budget;
a PDU set with a transmission error rate exceeding a PDU set transmission error rate threshold;
a second PDU set that is initiatively dropped based on a transmission failure of a first PDU set;
a PDU set with a priority lower than a preset priority;
a PDU set depending on other PDU sets; or
a PDU set with an importance lower than a preset importance.

In an embodiment, the first PDU set and the second PDU set have a relationship including at least one of:
the second PDU set depending on the first PDU set;
an importance of the second PDU set being lower than an importance of the first PDU set; or
a priority of the second PDU set being lower than a priority of the first PDU set.

In an embodiment, the one or more initiatively dropped data packets include at least one of:
a data packet with a transmission delay time exceeding a data packet transmission delay budget;
a data packet with a transmission error rate exceeding a data packet transmission error rate threshold;
a second data packet that is initiatively dropped based on a transmission failure of a first data packet;
a data packet with a priority lower than a preset priority;
a data packet depending on other data packets; or
a data packet with an importance lower than a preset importance.

In an embodiment, the first data packet and the second data packet belong to a same PDU set, and have a relationship including at least one of:
the second data packet depending on the first data packet;
an importance of the second data packet being lower than an importance of the first data packet; or
a priority of the second data packet being lower than a priority of the first data packet.

In an embodiment, a data flow for the one or more dropped data packets is an XR service data flow or a multimodal data service data flow.

In an embodiment, the SMF entity 300 further includes:
a receiving module, configured to receive the charging offset indication sent by a PCF entity.

In an embodiment, the receiving module is configured to:
receive, in an establishment or modification procedure of a packet data unit (PDU) session, the charging offset indication sent by the PCF entity.

In an embodiment, the sending module is configured to:
send the charging offset indication to a UPF entity.

In an embodiment, one or more charging scenarios for the charging correction include at least one of:
a scenario of charging based on the volume;
a scenario of charging based on combination of the volume and a time;
a scenario of charging based on combination of the volume and an event; or
a scenario of charging based on combination of the volume, the time, and the event.

In an embodiment, one or more charging methods for the charging correction include at least one of:
online charging;
offline charging; or
integrating charging.

The specific manners in which each of the modules of the above apparatus embodiments performs operations have been described in detail in the embodiments related to the method, and will not be explained here in detail.

An embodiment of the present disclosure provides a communication system, including: a PCF entity, an SMF entity, and an access network node; where
the PCF entity is configured to send the charging offset indication to the SMF entity;
the SMF entity is configured to send the charging offset indication to the access network node; and
the access network node is configured to receive the charging offset indication sent by the SMF entity, and determine, according to the charging offset indication, whether the charging correction for one or more dropped data packets is to be performed.

In an embodiment, accuracy the charging offset indication is carried in charging information included in a PCC rule; and/or
the charging offset indication is carried in related policy information of a PDU session; and/or
the charging offset indication is carried in related policy information of a PDU set.

In an embodiment, the one or more dropped data packets include: one or more PDU sets initiatively dropped by the access network node and/or one or more data packets in a PDU set initiatively dropped by the access network node in PDU set based QoS handling.

In an embodiment, the one or more initiatively dropped PDU sets include at least one of:
a PDU set with a transmission delay time exceeding a PDU set transmission delay budget;
a PDU set with a transmission error rate exceeding a PDU set transmission error rate threshold;
a second PDU set that is initiatively dropped based on a transmission failure of a first PDU set;
a PDU set with a priority lower than a preset priority;
a PDU set depending on other PDU sets; or
a PDU set with an importance lower than a preset importance.

In an embodiment, the first PDU set and the second PDU set have a relationship including at least one of:
the second PDU set depending on the first PDU set;
an importance of the second PDU set being lower than an importance of the first PDU set; or
a priority of the second PDU set being lower than a priority of the first PDU set.

In an embodiment, the one or more initiatively dropped data packets include at least one of:
a data packet with a transmission delay time exceeding a data packet transmission delay budget;
a data packet with a transmission error rate exceeding a data packet transmission error rate threshold;
a second data packet that is initiatively dropped based on a transmission failure of a first data packet;
a data packet with a priority lower than a preset priority;
a data packet depending on other data packets; or
a data packet with an importance lower than a preset importance.

In an embodiment, the first data packet and the second data packet belong to a same PDU set, and have a relationship including at least one of:
the second data packet depending on the first data packet;
an importance of the second data packet being lower than an importance of the first data packet; or
a priority of the second data packet being lower than a priority of the first data packet.

In an embodiment, a data flow for the one or more dropped data packets is an XR service data flow or a multimodal data service data flow.

In an embodiment, the PCF entity is configured to:
send, in an establishment or modification procedure of a PDU session, the charging offset indication to the SMF entity.

In an embodiment, the SMF entity is configured to:
send the charging offset indication to a UPF entity.

In an embodiment, the access network node is configured to:
determine that the charging correction for the one or more dropped data packets is performed; and
send volume information of the one or more dropped data packets and/or a data packet with a drop sign to a UPF entity.

In an embodiment, one or more charging scenarios for the charging correction include at least one of:
a scenario of charging based on the volume;
a scenario of charging based on combination of the volume and a time;
a scenario of charging based on combination of the volume and an event; or
a scenario of charging based on combination of the volume, the time, and the event.

In an embodiment, one or more charging methods for the charging correction include at least one of:
online charging;
offline charging; or
integrating charging.

An embodiment of the present disclosure provides a communication device, including:
a processor; and
a memory storing instructions executable by the processor;
where the processor is configured to, when executing the executable instructions, implement the charging processing method provided in any of the above technical solutions.

The processor may include various types of storage mediums. The storage mediums are non-transitory computer storage mediums, and can continue to memorize information stored in the storage mediums after the communication device is powered off.

Here, the communication device includes a core network device, an access network device, etc. Here, the access network device may include a base station, and the core network device may include a PCF entity and an SMF entity.

The processor may be connected to the memory through a bus or the like, and is configured to read an executable program stored in the memory, to implement for example, at least one of the charging processing methods shown in FIGS. 2 to 6.

As shown in FIG. 11, an embodiment of the present disclosure shows a structure of a network device. Referring to FIG. 11, the communication device 900 includes a processing component 922, that further includes one or more processors, and memory resources represented by a memory 932, for storing instructions that is executable by the processing component 922, such as an application program. The application program stored in the memory 932 may include one or more modules that each corresponds to a set of instructions. In addition, the processing component 922 is configured to execute the instructions to perform the charging processing method provided in any one of the above embodiments.

The communication device 900 may also include a power component 926 configured to perform power management of the communication device 900, a wired or wireless network interface 950 configured to connect the communication device 900 to the network, and an input/output (I/O) interface 958. The communication device 900 may operate an operating system stored in the memory 932, such as Windows Server™, Mac OS X™, Unix™, Linux™, FreeBSD™, or a similar operating system.

In an exemplary embodiment, a non-transitory computer-readable storage medium including instructions is further provided, such as the memory 932 including the instructions. The above instructions may be executed by the processing component 922 of the communication device 900 to implement any method applied to the communication device. For example, the non-transitory computer-readable storage medium may be a ROM, a random access memory (RAM), a CD-ROM, a magnetic tape, a floppy disk, an optical data storage device, etc.

Those skilled in the art will easily come up with other implementation solutions of the present disclosure after considering the specification and practicing the present disclosure disclosed herein. The present disclosure aims to cover any variations, uses, or adaptive changes of the present disclosure, which follow general principles of the present disclosure and include common knowledge or customary technical means in the art not disclosed in the present disclosure. The specification and embodiments are only considered exemplary, and the true scope and spirit of the present disclosure are indicated by the following claims.

It should be understood that the present disclosure is not limited to the precise structure described above and shown in the accompanying drawings, and various modifications and changes may be made without departing from its scope. The scope of the present disclosure is limited only by the appended claims.

In an embodiment, the charging offset indication is carried in charging information included in a policy control and charging (PCC) rule; and/or the charging offset indication is carried in related policy information of a packet data unit (PDU) session; and/or the charging offset indication is carried in related policy information of a PDU set.

In an embodiment, the one or more dropped data packets include: one or more PDU sets initiatively dropped by the access network node and/or one or more data packets in a PDU set initiatively dropped by the access network node in PDU set based QoS handling.

In an embodiment, the one or more initiatively dropped PDU sets include at least one of: a PDU set with a transmission delay time exceeding a PDU set transmission delay budget; a PDU set with a transmission error rate exceeding a PDU set transmission error rate threshold; a second PDU set that is initiatively dropped based on a transmission failure of a first PDU set; a PDU set with a priority lower than a preset priority; a PDU set depending on other PDU sets; or a PDU set with an importance lower than a preset importance.

In an embodiment, the first PDU set and the second PDU set have a relationship including at least one of: the second PDU set depending on the first PDU set; an importance of the second PDU set being lower than an importance of the first PDU set; or a priority of the second PDU set being lower than a priority of the first PDU set.

In an embodiment, the one or more initiatively dropped data packets include at least one of: a data packet with a transmission delay time exceeding a data packet transmission delay budget; a data packet with a transmission error rate exceeding a data packet transmission error rate threshold; a second data packet that is initiatively dropped based on a transmission failure of a first data packet; a data packet with a priority lower than a preset priority; a data packet depending on other data packets; or a data packet with an importance lower than a preset importance.

In an embodiment, the first data packet and the second data packet belong to a same PDU set, and have a relationship including at least one of: the second data packet depending on the first data packet; an importance of the second data packet being lower than an importance of the first data packet; or a priority of the second data packet being lower than a priority of the first data packet.

In an embodiment, a data flow for the one or more dropped data packets is an XR service data flow or a multimodal data service data flow.

In an embodiment, the method further includes: determine that the charging correction for the one or more dropped data packets is performed; and send volume information of the one or more dropped data packets and/or a data packet with a drop sign to a UPF entity.

In an embodiment, accuracy the charging offset indication is carried in charging information included in a policy control and charging (PCC) rule; and/or the charging offset indication is carried in related policy information of a PDU session; and/or the charging offset indication is carried in related policy information of a PDU set.

In an embodiment, the one or more dropped data packets include: one or more PDU sets initiatively dropped by the access network node and/or one or more data packets in a PDU set initiatively dropped by the access network node in PDU set based QoS handling.

In an embodiment, the one or more initiatively dropped PDU sets include at least one of: a PDU set with a transmission delay time exceeding a PDU set transmission delay budget; a PDU set with a transmission error rate exceeding a PDU set transmission error rate threshold; a second PDU set that is initiatively dropped based on a transmission failure of a first PDU set; a PDU set with a priority lower than a preset priority; a PDU set depending on other PDU sets; or a PDU set with an importance lower than a preset importance.

In an embodiment, the first PDU set and the second PDU set have a relationship including at least one of: the second PDU set depending on the first PDU set; an importance of the second PDU set being lower than an importance of the first PDU set; or a priority of the second PDU set being lower than a priority of the first PDU set.

In an embodiment, the one or more initiatively dropped data packets include at least one of: a data packet with a transmission delay time exceeding a data packet transmission delay budget; a data packet with a transmission error rate exceeding a data packet transmission error rate threshold; a second data packet that is initiatively dropped based on a transmission failure of a first data packet; a data packet with a priority lower than a preset priority; a data packet depending on other data packets; or a data packet with an importance lower than a preset importance.

In an embodiment, the first data packet and the second data packet belong to a same PDU set, and have a relationship including at least one of: the second data packet depending on the first data packet; an importance of the second data packet being lower than an importance of the first data packet; or a priority of the second data packet being lower than a priority of the first data packet.

In an embodiment, a data flow for the one or more dropped data packets is an XR service data flow or a multimodal data service data flow.

In an embodiment, sending the charging offset indication to the SMF entity includes: sending, in an establishment or modification procedure of a PDU session, the charging offset indication to the SMF entity.

In an embodiment, accuracy the charging offset indication is carried in charging information included in a policy control and charging (PCC) rule; and/or the charging offset indication is carried in related policy information of a PDU session; and/or the charging offset indication is carried in related policy information of a PDU set.

In an embodiment, the one or more dropped data packets include: one or more PDU sets initiatively dropped by the access network node and/or one or more data packets in a PDU set initiatively dropped by the access network node in PDU set based QoS handling.

In an embodiment, the one or more initiatively dropped PDU sets include at least one of: a PDU set with a transmission delay time exceeding a PDU set transmission delay budget; a PDU set with a transmission error rate exceeding a PDU set transmission error rate threshold; a second PDU set that is initiatively dropped based on a transmission failure of a first PDU set; a PDU set with a priority lower than a preset priority; a PDU set depending on other PDU sets; or a PDU set with an importance lower than a preset importance.

In an embodiment, the first PDU set and the second PDU set have a relationship including at least one of: the second PDU set depending on the first PDU set; an importance of the second PDU set being lower than an importance of the first PDU set; or a priority of the second PDU set being lower than a priority of the first PDU set.

In an embodiment, the one or more initiatively dropped data packets include at least one of: a data packet with a transmission delay time exceeding a data packet transmission delay budget; a data packet with a transmission error rate exceeding a data packet transmission error rate threshold; a second data packet that is initiatively dropped based on a transmission failure of a first data packet; a data packet with a priority lower than a preset priority; a data packet depending on other data packets; or a data packet with an importance lower than a preset importance.

In an embodiment, the first data packet and the second data packet belong to a same PDU set, and have a relationship including at least one of: the second data packet depending on the first data packet; an importance of the second data packet being lower than an importance of the first data packet; or a priority of the second data packet being lower than a priority of the first data packet.

In an embodiment, a data flow for the one or more dropped data packets is an XR service data flow or a multimodal data service data flow.

In an embodiment, the method further includes: receiving the charging offset indication sent by a PCF entity.

In an embodiment, receiving the charging offset indication sent by the PCF entity includes: receiving, in an establishment or modification procedure of a PDU session, the charging offset indication sent by the PCF entity.

In an embodiment, the method further includes: sending the charging offset indication to a UPF entity.

A seventh aspect of the embodiments of the present disclosure provides an access network node, including: a receiving module, configured to receive a charging offset indication sent by an SMF entity; and a processing module, configured to determine, according to the charging offset indication, whether a charging correction for one or more dropped data packets is to be performed.

An eighth aspect of the embodiments of the present disclosure provides a PCF entity, including: a sending module, configured to send a charging offset indication to an SMF entity, where the charging offset indication indicates whether an access network node is to perform a charging correction for one or more dropped data packets.

A ninth aspect of the embodiments of the present disclosure provides an SMF entity, including: a sending module, configured to send a charging offset indication to an access network node, where the charging offset indication indicates whether the access network node is to perform a charging correction for one or more dropped data packets.

1. A charging processing method, performed by an access network node and comprising:
receiving a charging offset indication sent by a session management function (SMF) entity; and
determining, according to the charging offset indication, whether a charging correction for one or more dropped data packets is to be performed.

2. The method of claim 1, wherein, the charging offset indication is carried in at least one of:
charging information comprised in a policy control and charging (PCC) rule;
policy information of a packet data unit (PDU) session; or
policy information of a PDU set.

3. The method of claim 1, wherein the one or more dropped data packets comprise:
one or more PDU sets initiatively dropped by the access network node in PDU set based quality of service (QoS) handling, and/or
one or more data packets in a PDU set initiatively dropped by the access network node.

4. The method of claim 3, wherein the one or more initiatively dropped PDU sets comprise at least one of:
a PDU set with a transmission delay time exceeding a PDU set transmission delay budget;
a PDU set with a transmission error rate exceeding a PDU set transmission error rate threshold;
a second PDU set that is initiatively dropped based on a transmission failure of a first PDU set; wherein the first PDU set and the second PDU set have a relationship comprising at least one of: the second PDU set depending on the first PDU set, an importance of the second PDU set being lower than an importance of the first PDU set, or a priority of the second PDU set being lower than a priority of the first PDU set;
a PDU set with a priority lower than a preset priority;
a PDU set depending on other PDU sets; or
a PDU set with an importance lower than a preset importance.

5. (canceled)

6. The method of claim 3, wherein the one or more initiatively dropped data packets comprise at least one of:
a data packet with a transmission delay time exceeding a data packet transmission delay budget;
a data packet with a transmission error rate exceeding a data packet transmission error rate threshold;
a second data packet that is initiatively dropped based on a transmission failure of a first data packet; wherein the first data packet and the second data packet belong to a same PDU set, and have a relationship comprising at least one of: the second data packet depending on the first data packet, an importance of the second data packet being lower than an importance of the first data packet, or a priority of the second data packet being lower than a priority of the first data packet;
a data packet with a priority lower than a preset priority;
a data packet depending on other data packets; or
a data packet with an importance lower than a preset importance.

7. (canceled)

8. The method of claim 1, wherein,
a data flow for the one or more dropped data packets is an extended reality (XR) service data flow or a multimodal data service data flow.

9. The method of claim 1, further comprising:
determining that the charging correction for the one or more dropped data packets is performed; and
sending volume information of the one or more dropped data packets and/or a data packet with a drop sign to a user plane function (UPF) entity.

10. A charging processing method, performed by a policy control function (PCF) entity and comprising:
sending a charging offset indication to a session management function (SMF) entity, wherein the charging offset indication indicates whether an access network node is to perform a charging correction for one or more dropped data packets.

11.-17. (canceled)

18. The method of claim 10, wherein the sending a charging offset indication to the SMF entity comprises:
sending, in an establishment or modification procedure of a PDU session, the charging offset indication to the SMF entity.

19. A charging processing method, performed by a session management function (SMF) entity and comprising:
sending a charging offset indication to an access network node, wherein the charging offset indication indicates whether the access network node is to perform a charging correction for one or more dropped data packets.

20.-26. (canceled)

27. The method of claim 19, further comprising:
receiving the charging offset indication sent by a policy control function (PCF) entity.

28. The method of claim 27, wherein the receiving the charging offset indication sent by the PCF entity, comprises:
receiving, in an establishment or modification procedure of a PDU session, the charging offset indication sent by the PCF entity.

29. The method of claim 19, further comprising:
sending the charging offset indication to a user plane function (UPF) entity.

30.-32. (canceled)

33. A communication device, comprising:
a processor; and
a memory storing instructions executable by the processor;
wherein the processor is configured to implement, when executing the instructions, the charging processing method of claim 1.

34. A communication system, comprising: a policy control function (PCF) entity, a session management function (SMF) entity, and an access network node; wherein
the PCF entity is configured to perform the charging processing method of claim 10;
the SMF entity is configured to perform the charging processing method of claim 19; and
the access network node is configured to perform the charging processing method of claim 1.

35. A non-transitory computer storage medium, storing a program executable by a computer; wherein when the program is executed by a processor, the charging processing method of claim 1 is implemented.

36. A communication device, comprising:
a processor; and
a memory storing instructions executable by the processor;
wherein the processor is configured to implement, when executing the instructions, the charging processing method of claim 10.

37. A communication device, comprising:
a processor; and
a memory storing instructions executable by the processor;
wherein the processor is configured to implement, when executing the instructions, the charging processing method of claim 19.

38. A non-transitory computer storage medium, storing a program executable by a computer; wherein when the program is executed by a processor, the charging processing method of claim 10 is implemented.

39. A non-transitory computer storage medium, storing a program executable by a computer; wherein when the program is executed by a processor, the charging processing method of claim 19 is implemented.
